(19) United States
(12) Patent Application Publication
(10) Pub. No.: US 2006/0226560 A1
(43) Pub. Date: Oct. 12, 2006

(54) METHOD FOR MANUFACTURING COMPOSITE LENS

(76) Inventor: Tai-Cherng Yu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,157

(22) Filed: Mar. 9, 2006

(30) Foreign Application Priority Data
Apr. 6, 2005 (CN) 200510034038.1

(51) Int. Cl. B29D 11/00

(52) U.S. Cl. 264/1.32; 264/1.38; 264/1.7

(57) ABSTRACT

This invention relates to a method for manufacturing a composite lens, comprising the steps of: forming a base-lens-forming material into a base lens; and forming a plastic material into a first plastic lens portion on a first lens surface of the base lens using a stamper by a hot embossing process, wherein a glass transition temperature of the plastic material is lower than that of the base-lens-forming material.

### FIELD OF THE INVENTION

This invention relates to a method for manufacturing an optical lens element, and more particularly, to a method for manufacturing a composite lens.

### DESCRIPTION OF RELATED ART

In an optical system, a great number of lens elements are generally employed for correcting chromatic aberrations, and monochromatic aberrations, such as spherical aberration, etc. Therefore, such optical system is generally unduly bulky.

In order to reduce the size and weight of the optical system, a composite lens is employed. Generally, the composite lens consists of a plurality of lens units. The lens units are generally combined together with a glue. However, with the size of the composite lens becoming smaller and smaller, it is difficult to combine more multiple lens units together to form a composite lens. In addition, due to the difference of expansion coefficient between the glue and the lens units, the lens units are prone to be separated from each other, thereby the optical properties of the composite lens may be deteriorated.

What is needed, therefore, is to provide an improved method for manufacturing a composite lens.

### SUMMARY OF INVENTION

A preferred embodiment provides a method for manufacturing a composite lens including the following steps of: forming a base-lens-forming material into a base lens; and forming a plastic material into a first plastic lens portion on a first lens surface of the base lens using a stamper by a hot embossing process, a glass transition temperature of the plastic material being lower than that of the base-lens-forming material.

In another preferred embodiment, a method for manufacturing composite lenses including the following steps of: forming a base-lens-forming material into a base lens plate consisting essentially of a plurality of base lens units; forming a plastic material into a first lens layer on a first lens surface of the base lens plate using a stamper by a hot embossing process thereby obtaining a composite lens plate, the first lens layer consisting essentially of a plurality of first lens units, spatially corresponding to the plurality of base lens units, a glass transition temperature of the plastic material being lower than that of the base-lens-forming material; and cutting the composite lens plate into a plurality of separate composite lenses each having a base lens unit and a respective first lens unit thereon.

Compared with the conventional methods for manufacturing a composite lens, a method for manufacturing a composite lens in accordance with a preferred embodiment can provides a composite lens have improved optical properties, which results from that the plastic lens portion is combined with the base lens together by the hot embossing process. In addition, a method for manufacturing composite lenses in accordance with another preferred embodiment can provide a plurality of composite lenses at one time, which can attain a high productivity.

Other advantages and novel features will become more apparent from the following detailed description of embodiments when taken in conjunction with the accompanying drawings.

### BRIEF DESCRIPTION OF DRAWINGS

Many aspects of the present method can be better understood with reference to the following drawings. The components in the drawings are not necessarily to scale, the emphasis instead being placed upon clearly illustrating the principles of the present method. Moreover, in the drawings, like reference numerals designate corresponding parts throughout the several views.

FIG. 1 is a schematic, cross-sectional view of a composite lens formed by a method for manufacturing a composite lens in accordance with a preferred embodiment of the present invention;

FIG. 2 is a schematic, cross-sectional view of a stage of the manufacturing method, showing a base-lens-forming material being stamped by two stampers each having a mirror-like surface portion;

FIG. 3 is a schematic, cross-sectional view of a subsequent stage of the manufacturing method, showing a base lens formed in the stage of FIG. 2;

FIG. 4 is a schematic, cross-sectional view of a further subsequent stage of the manufacturing method, showing plastic materials being disposed between the base lens and two corresponding stampers;

FIG. 5 is a schematic, cross-sectional view of a stage of a method for manufacturing composite lenses in accordance with another preferred embodiment of present invention, showing a base-lens-forming material being stamped by two stampers each having a plurality of mirror-like surface portions;

FIG. 6 is a schematic, cross-sectional view of a subsequent stage of the manufacturing method, showing a base lens plate consisting essentially of a plurality of base lens units formed in the stage of FIG. 5;

FIG. 7 is a schematic, cross-sectional view of further subsequent stage of the manufacturing method, showing plastic materials being disposed between the base lens and two corresponding stampers; and

FIG. 8 is a schematic, cross-sectional view of a composite lens plate consisting essentially of a plurality of composite lenses formed in the stage of FIG. 7.

The exemplifications set out herein illustrate at least one preferred embodiment of the method in one form, and such exemplifications are not to be construed as limiting the scope of the invention in any manner.

### DETAILED DESCRIPTION

Reference will now be made to the drawing figures to describe the present invention in detail.

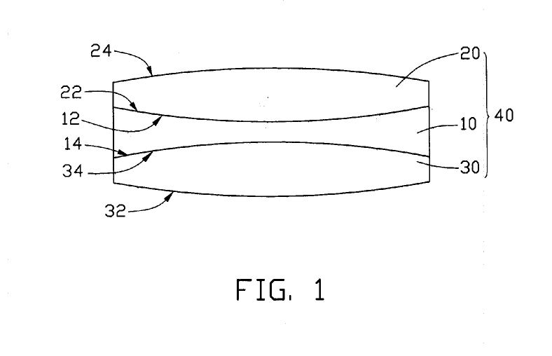

Referring to FIG. 1, a composite lens 40 formed by a method for making a composite lens in accordance with a preferred embodiment of the present invention is shown. The composite lens 40 includes a base lens 10 and two plastic lens portions 20, 30. The base lens 10 has two opposite lens surfaces 12, 14. The plastic lens portions 20, 30 are formed on the opposite lens surfaces 12, 14 by means of a hot embossing process, respectively.

The base lens 10 is usually made of for example glass having a glass transition temperature in a range about from 500 to 700 degrees Celsius. The plastic lens portions 20, 30 are usually made of a plastic material, such as a thermoplastic material, an ultraviolet curable materials, etc. The thermoplastic material can be polycarbonate (PC), polystyrene (PS), polymethylmethacrylate (PMMA), etc. The ultraviolet curable material can be polydimethylsiloxane (PDMS), etc. A glass transition temperature of the plastic material is usually in a range from about 70 to about 130 degrees Celsius.

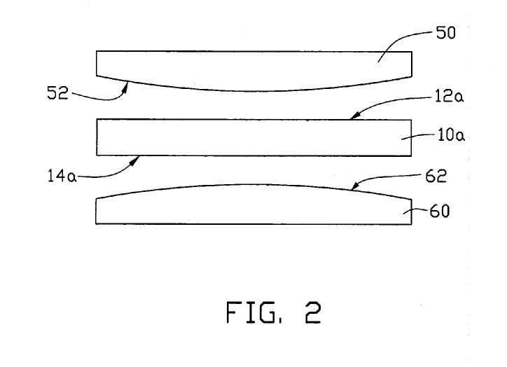

FIGS. 2 to 4, illustrate successive stages of the method for manufacturing the composite lens 40.

Referring to FIG. 2, a base-lens-forming material, such as a glass plate 10a, and two stampers 50, 60 are provided for manufacturing a base lens 10. The glass plate 10a has two opposite surfaces 12a, 14a. The stamper 50 has a mirror-like surface portion 52 formed on a side thereof, and the mirror-like surface portion 52 may be convex, or non-convex, such as concave. The stamper 60 has a mirror-like surface portion 62 formed on a side thereof, and the mirror-like surface portion 62 may be convex, or non-convex, such as concave. In the illustrated embodiment, the mirror-like surface portions 52, 62 are convex. The mirror-like surface portions 52, 62 can be formed by an ultraviolet lithography electroforming micro-molding (hereinafter referred as UV-LIGA) process. A hot embossing process for manufacturing a base lens 10 may include the steps in no particular order of: disposing the stamper 50 in a manner such that the mirror-like surface portion 52 thereof faces the surface 12a of the glass plate 10a, and disposing the stamper 60 in a manner such that the mirror-like surface portion 62 thereof faces the surface 14a of the glass plate 10a; heating the glass plate 10a to or above a glass transition temperature thereof, such as about 600 degrees Celsius; pressing the stampers 50, 60 toward the surfaces 12a, 14a of the glass plate 10a so as to form the base lens 10; cooling the glass plate 10a to room temperature, and removing the stampers 50, 60 thereby obtaining the base lens 10.

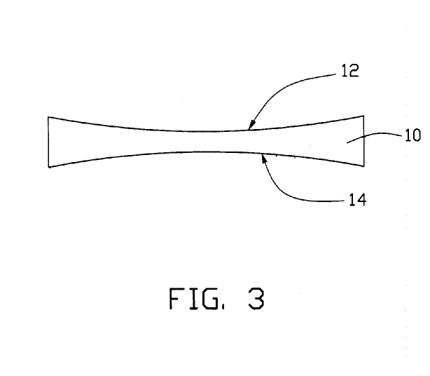

Referring to FIG. 3, the base lens 10 having two lens surfaces 12, 14 is shown. The surfaces 12a, 14a of the glass plate 10a are transformed into the lens surfaces 12, 14 of the base lens 10 respectively. The lens surfaces 12, 14 are consistent with the mirror-like surface portions 52 and 62 respectively. In the illustrated embodiment, the lens surfaces 12, 14 are concave. Alternatively, the base lens 10 could be formed by an injection molding process.

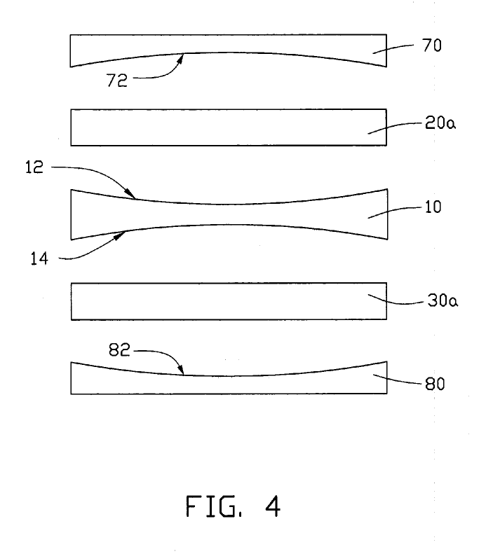

Referring to FIG. 4, two stampers 70, 80, and two plastic materials 20a, 30a are provided for forming two plastic lens portions 20, 30 on two opposite lens surfaces 12, 14 of the base lens 10. The plastic materials 20a, 30a are thermoplastic materials, such as polycarbonate, and have the same glass transition temperature. The stamper 70 has a mirror-like surface portion 72, and the mirror-like surface portion 72 may be convex, or non-convex, such as concave. The stamper 80 has a mirror-like surface portion 82, and the mirror-like surface portion 82 may be convex, or non-convex, such as concave. In the illustrated embodiment, the mirror-like surface portions 72, 82 are concave. The mirror-like surface portions 72, 82 can be formed by an UV-LIGA process. Another hot embossing process for forming two plastic lens portions 20, 30 on two opposite lens surfaces 12, 14 of the base lens 10 may include the steps in no particular order of: disposing the plastic material 20a between the mirror-like surface portion 72 of the stamper 70 and the lens surface 12 of the base lens 10; disposing the plastic material 30a between the mirror-like surface portion 82 of the stamper 80 and the lens surface 14 of the base lens 10; heating the plastic materials 20a, 30a to or above a glass transition temperature thereof; pressing the plastic materials 20a, 30a toward the lens surfaces 12, 14 respectively by applying pressures onto the stampers 70, 80. Then a composite lens 40 having two plastic lens portions 20, 30 is formed (as shown in FIG. 1), after the plastic materials 20a, 30a are cooled down to room temperature, and the stampers 70, 80 are removed. If the plastic materials 20a, 30a are an ultraviolet curable material, such as PDMS, a curing step, i.e. applying an ultraviolet radiation to the plastic materials 20a, 30a, prior to removing the stampers 70, 80 could be performed instead.

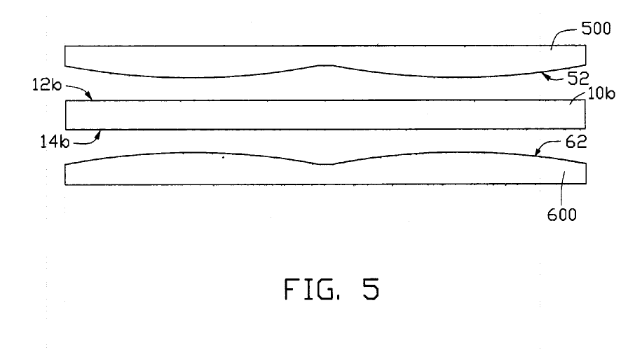

FIGS. 5 to 7, illustrate successive stages of a method for manufacturing a plurality of composite lenses 40 in accordance with another embodiment of the present invention.

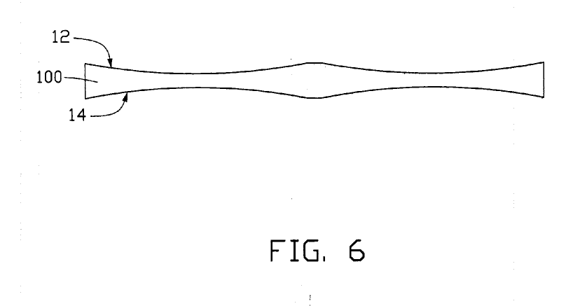

Referring to FIG. 5, a base-lens-forming material, such as a glass plate 10b, and two stampers 500, 600 are provided for manufacturing a base lens plate 100 (see FIG. 6). The base lens plate 100 consists essentially of a plurality of base lens units arranged in a pattern, for example an array. In the illustrated embodiment, the base lens plate 100 consists essentially of two base lens units. The glass plate 10b has two opposite surface 12b, 14b. The stamper 500 has a plurality of mirror-like surface portions 52 arranged corresponding to the pattern of the base lens units, and the mirror-like surface portions 52 may be convex, or non-convex, such as concave. The stamper 600 has a plurality of mirror-like surface portions 62 arranged corresponding to the pattern of the base lens units, and the mirror-like surface portions 62 may be convex, or non-convex, such as concave. In the illustrated embodiment, the mirror-like surface portions 52, 62 are convex, and can be formed by an UV-LIGA process. A hot embossing process for manufacturing a base lens plate 100 may include the steps in no particular order of: disposing the stamper 500 in a manner such that the mirror-like surface portions 52 thereof faces the surface 12b of the glass plate 10b; and disposing the stamper 600 in a manner such that the mirror-like surface portions 62 thereof faces the surface 14b of the glass plate 10b; heating the glass plate 10b to or above a glass transition temperature thereof, such as about 600 degrees Celsius; pressing the stampers 500, 600 toward the surfaces 12b, 14b of the glass plate 10b so as to form the base lens plate 100; cooling the glass plate 10b to room temperature, and removing the stampers 500, 600 thereby obtaining the base lens plate 100.

Referring to FIG. 6, a base lens plate 100 consisting of two base lens units is shown. Each of the base lens units has opposite lens surfaces 12, 14 which are transformed from the surfaces 12b, 14b of the glass plate 10b. The lens surfaces 12, 14 are consistent with the mirror-like surface portions 52 and 62 respectively. Alternatively, the base lens plate 100 could be formed by an injection molding process.

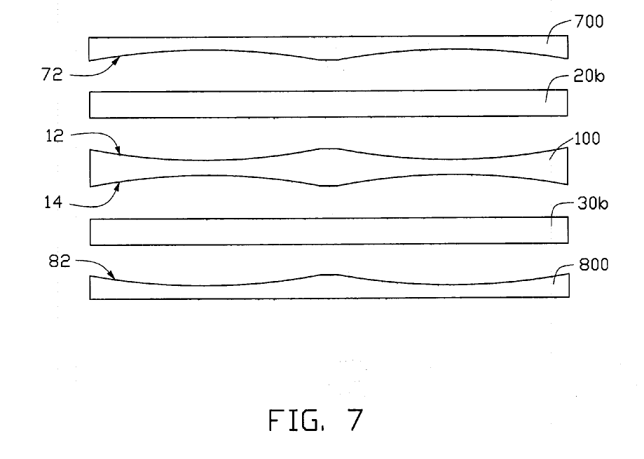

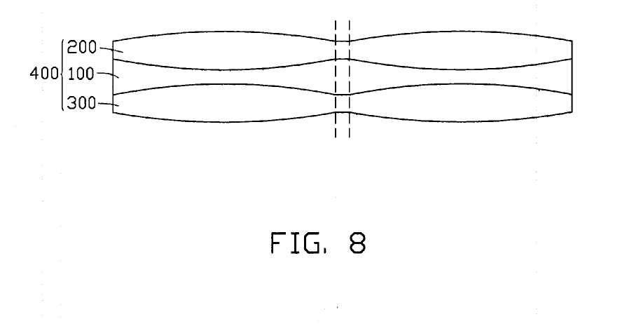

Referring to FIG. 7, two stampers 700, 800, and two plastic materials 20b, 30b are provided for forming two opposite plastic lens layers 200, 300 (see FIG. 8) each consisting of two plastic lens portions on the base lens plate 100. The plastic lens portions are spatially corresponding to the base lens units of the base lens plate 100. The two plastic materials 20b, 30b are thermoplastic materials, such as polycarbonate, and have the same glass transition temperature. The stamper 700 has a plurality of mirror-like surface portions 72 arranged corresponding to the pattern of the base lens units, and the mirror-like surface portions 72 may be convex, or non-convex, such as concave. The stamper 800 has a plurality of mirror-like surface portions 82 arranged corresponding to the pattern of the base lens units, and the mirror-like surface portions 82 may be convex, or non-convex, such as concave. In the illustrated embodiment, the mirror-like surface portions 72, 82 are concave, and can be formed by an UV-LIGA process. A hot embossing process for forming two opposite plastic lens layers 200, 300 each consisting of two plastic lens portions on the base lens plate 100 may include the steps in no particular order of: disposing the plastic material 20b between the mirror-like surface portions 72 of the stamper 700 and the lens surfaces 12 of the base lens units, and disposing the plastic material 30b between the mirror-like surface portions 82 of the stamper 800 and the lens surfaces 14 of the base lens units; heating the plastic materials 20b, 30b to or above a glass transition temperature thereof; pressing the plastic materials 20b, 30b toward the lens surfaces 12, 14 respectively by applying pressures onto the stampers 700, 800. Then, a composite lens plate 400 consisting of two composite lens units is obtained (as shown in FIG. 8), after the plastic materials 20b, 30b are cooled down to room temperature, and the stampers 700, 800 are removed. If the plastic materials 20b, 30b are ultraviolet curable materials, such as polydimethylsiloxane, a curing step, i.e. applying an ultraviolet radiation thereto prior to removing the stampers 700, 800 could be performed instead.

Referring to FIG. 8, a composite lens plate 400 consisting of two composite lenses are shown. After cutting the composite lens plate 400 into two pieces along a dash line (as shown in FIG. 8), two separate composite lenses each consisting of a base lens unit and two plastic lens portions formed thereon are obtained at one time. It could be understood by those skilled in the art, mirror-like surface portions of a stamper, such as stamper 500, 600, 700 or 800, may have different shapes.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a composite lens, comprising the steps of:
forming a base-lens-forming material into a base lens; and
forming a plastic material into a first plastic lens portion on a first lens surface of the base lens using a stamper by a hot embossing process, a glass transition temperature of the plastic material being lower than that of the base-lens-forming material.

2. The method of claim 1, wherein the base lens is formed by a hot embossing process.

3. The method of claim 1, further comprising the steps of:
forming a second plastic lens portion on an opposite second lens surface of the base lens using another stamper by the hot embossing process.

4. The method of claim 1, wherein the base-lens-forming material is comprised of glass.

5. The method of claim 1, wherein the plastic material is a thermoplastic material.

6. The method of claim 5, wherein the thermoplastic material is selected from the group consisting of polycarbonate, polystyrene and polymethylmethacrylate.

7. The method of claim 1, wherein the plastic material is an ultraviolet curable material, and the method further comprises the step of curing the plastic material by applying an ultraviolet radiation thereto.

8. The method of claim 7, wherein the ultraviolet curable material is polydimethylsiloxane.

9. The method of claim 1, wherein the stamper has a mirror-like surface portion that is formed by an ultraviolet lithography electroforming micro-molding process.

10. A method for manufacturing composite lenses, comprising the steps of: forming a base-lens-forming material into a base lens plate consisting essentially of a plurality of base lens units; forming a plastic material into a first lens layer on a first lens surface of the base lens plate using a stamper by a hot embossing process thereby obtaining a composite lens plate, the first lens layer consisting essentially of a plurality of first lens units, spatially corresponding to the plurality of base lens units, a glass transition temperature of the plastic material being lower than that of the base-lens-forming material; and
cutting the composite lens plate into a plurality of separate composite lenses each having a base lens unit and a respective first lens unit thereon.

11. The method of claim 10, wherein the base lens plate is formed by a hot embossing process.

12. The method of claim 10, further comprising the following step prior to the cutting step:
forming a second lens layer on an opposite second lens surface of the base lens plate using another stamper by a hot embossing process, the second lens layer consisting essentially of a plurality of second lens units, spatially corresponding to the plurality of base lens units.

13. The method of claim 10, wherein the base-lens-forming material is comprised of glass.

14. The method of claim 10, wherein the plastic material is a thermoplastic material.

15. The method of claim 14, wherein the thermoplastic material is selected from the group consisting of polycarbonate, polystyrene and polymethylmethacrylate.

16. The method of claim 10, wherein the plastic material is an ultraviolet curable material, and the method further comprises the step of curing the plastic material by applying an ultraviolet radiation thereto.

17. The method of claim 16, wherein the ultraviolet curable material is polydimethylsiloxane.

18. The method of claim 10, wherein the stamper has a plurality of mirror-like surface portions that are formed by an ultraviolet lithography electroforming micro-molding process.
